(19) United States
(12) Patent Application Publication
(10) Pub. No.: US 2007/0070999 A1
(43) Pub. Date: Mar. 29, 2007

(54) Synchronization of historical data without retransmission

(76) Inventors: Jeffrey T. Black, Boston, MA (US); Myron Zimmerman, Needham, MA (US)

Correspondence Address: GOODWIN PROCTER LLP;PATENT ADMINISTRATOR, EXCHANGE PLACE, BOSTON, MA, 02109-2881, US

(21) Appl. No.: 11/491,787

(22) Filed: Jul. 24, 2006

Related U.S. Application Data
(60) Provisional application No. 60/704,856, filed on Aug. 2, 2005.

(51) Int. Cl. H04L 12/56; H04J 3/18

(52) U.S. Cl. 370/389; 370/477

(57) ABSTRACT

In one embodiment of the present invention, a first node receives acknowledgement indications from a second node describing which previously processed and transmitted data have been successfully received and processed by the second node. In response to these indications, the first node makes the corresponding data in its history buffer available for subsequent processing. In this way, the first node utilizes for processing that data which also available to the second node for subsequent processing, providing consistent use of evolving historical data without the need for a reliable protocol between nodes. In further embodiments, a packet is processed at a first node utilizing stored data relating to previously-processed packets and then transmitted from the first node to a second node. The transmitted packet is subsequently processed at the second node utilizing stored data relating to packets previously processed at the second node.

### CROSS-REFERENCE TO RELATED CASES

This application claims the benefit of U.S. Provisional Patent Application No. 60/704,856, filed on Aug. 2, 2005, which is hereby incorporated by reference as if set forth herein in its entirety.

### FIELD OF THE INVENTION

This invention relates to a method and system for communicating data and, more particularly, to a method and system for synchronizing historical data between a first node and second node without the retransmission of data.

### BACKGROUND OF THE INVENTION

In today's data networks, individual blocks of information, called “packets,” are transmitted between computers or other equipment which are interconnected via some physical medium. More specifically, a multi-layered networking model is generally employed which abstracts discrete network-related functions into separate layers in order facilitate independence of functions, and allow for incremental advancement of features and capabilities.

Internet Protocol (IP) based networks, including the Internet, conform to this multi-layered model. For example, a computer communicating over the Internet may utilize copper wire and electronic transceivers as a layer 1 (physical layer) technology, Ethernet for layer 2 (data link layer) technology, and IP for layer 3 (network layer) technology. Additional higher layers are typically employed as well. These can include transmission control protocol (“TCP”), hypertext transfer protocol (“HTTP”), messaging application programming interface (“MAPI”), and common internet file system (“CIFS”), among others.

When communicating, the computer transmits and receives packets of information to and from other computers, usually by way of intermediate networking devices such as switches, routers, modems, and the like. At each device along the path, processing is performed such that the information packet can be relayed to its final destination. This intermediate processing is usually, although not always, limited to layers 1 through 3.

In today's environments, the speed with which communicating computers can exchange information is often limited by the performance of the network infrastructure connecting them. While the processing latency of intermediate networking devices is one factor limiting performance, by far the greatest factor typically limiting network performance is the speed with which packets can be transmitted over the physical layer between devices. This limitation is most prevalent in wide area networks, where last-mile links are often over low-speed copper facilities operating at or below T1 rates (1.5 Mbps).

One approach for increasing the rate of information transfer over wide area networks with low speed links is to perform data compression on the packets being transmitted. Data compression can remove redundant information from the packets, thereby allowing higher effective information transmission rates over a given link. However, because packet compression schemes are typically performed on layer 2 (e.g., Frame Relay) or layer 3 (e.g., IP) packets, they cannot benefit from the reliability afforded by higher layer protocols such as TCP. Therefore, these layer 2 or layer 3 compression schemes must somehow accommodate the fact that transmitted packets may be lost or received out of order between the steps of compression and decompression.

For this reason, known packet-oriented data-compression systems have typically taken one of two approaches for dealing with intervening packet loss and reordering. The first is to simply not maintain any dependency of compression processing between packets. In other words, no historical data or other stateful information is maintained from one packet to the next and each packet is compressed (and thus decompressed) independently. While this removes all need for compressor-to-decompressor synchronization and is free of effects from lost, corrupted, or out-of-order packets, it has the considerable drawback of suffering from poor compression performance.

The second approach taken is to ensure the reliable transmission of compressed packets between the compressor and the decompressor. This approach enables the maintenance of historical data across packets, and thus greatly improves compression performance. However, it can require the implementation of a reliable protocol comprising session initialization and packet accounting and retransmission, effectively duplicating the processing already being done at the higher transport layer.

Accordingly, there is a need for methods and apparatus to synchronize compressor and decompressor processing of packets of data without duplicating the processing itself or compromising compression quality.

### SUMMARY OF THE INVENTION

Embodiments of the present invention provide an improved approach whereby historical data can be maintained between the compressor and decompressor (thus improving compression performance), but without the complexity and overhead of maintaining a reliable protocol in between. Other embodiments of the invention provide for the consistent maintenance of historical data between paired operators such as, e.g., an encryptor and a decryptor, etc.

In particular, the present invention allows for synchronized updates to historical reference data utilized by two communicating nodes in a network without the need to maintain a reliable transport protocol between the nodes. The technique may be applied to a compressing node which maintains a history buffer containing data from packets which it has compressed, discrete segments or windows of which are available as a reference for compressing new data; and a decompressing node which maintains a history buffer containing data from packets which it has decompressed and which is available as a reference for decompressing new data. Employing this technique, the compressing node receives acknowledgement indications from the decompressing node describing which windows of new data have been successfully decompressed by the decompressing node. In response to these indications, the compressing node makes the corresponding windows in its history buffer available for subsequent compression operations. In this way, the compressing node utilizes for compression only that data which is also available to the decompressing node for subsequent decompression, ensuring consistent use of evolving historical data without the need for a reliable protocol between the nodes.

The invention is amenable to applications beyond compression. For example, it may be applied to packet encryption and decryption, forward error correction, and other operations involving complementary processing at transmitting and receiving nodes.

With reference to FIG. 1A, in a first aspect, a method of communicating data includes selecting, at a first node, a packet for processing (Step 50). The packet is processed at the first node utilizing, at least in part, stored data relating to previously-processed packets (Step 54), and is transmitted from the first node to a second node in the usual fashion (Step 58). The packet is then processed at the second node utilizing, at least in part, stored data relating to packets previously processed at the second node (Step 62).

In some embodiments, the method further comprises storing, accessibly to the first node, processing data from the processed packet. In one embodiment, the processing at the first node comprises compression and the processing at the second node comprises decompression. When the process involves compression and decompression, the method may also include storing, accessibly to the second node, decompression data from the decompressed packet. The method may further comprise transmitting an acknowledgment, from the second node to the first node, indicating successful decompression at the second node of the transmitted packet. The acknowledgment may be transmitted form the second node to the first node over a wide area network. Furthermore, the data used for compressing packets may only be associated with compressed packets previously transmitted to the second node and for which acknowledgments were received.

The processing at the first node may instead comprise encryption and the processing at the second node may comprise decryption. Moreover, the processed packet may be transmitted from the first node to the second node over a wide area network. In some embodiments, the method may further comprise transmitting, from the second node to the first node, an acknowledgment indicating successful processing of the transmitted packet at the second node.

In another aspect, a device for transmitting data packets over a computer network comprises a packet buffer; a history buffer for storing processing data from processed packets; a processing module for processing packets from the packet buffer based at least in part on data in the history buffer; and a communication module for transmitting, to destination nodes, packets processed by the processing module.

The processing module may be a compression module, wherein the processing comprises compression, a decompression module, wherein the processing comprises decompression, an encryption module, wherein the processing comprises encryption, or a decryption module, wherein the processing comprises decryption. In some embodiments, the communication module transmits over a wide area network. The communication module may be further configured to receive an acknowledgment from a destination node indicating successful processing of a packet transmitted by the device. The acknowledgment may be received from the destination node through a wide area network. Moreover, the data used by the processing module may be drawn from packets for which acknowledgements have been received.

In some embodiments, the communication module is further configured to receive compressed packets from other nodes, and the device further comprises a decompression history buffer and a decompression module for decompressing packets received from other nodes based at least in part on data in the decompression history buffer and storing decompression data from decompressed packets in the decompression history buffer. In these embodiments, the device may further comprise functionality for transmitting an acknowledgment to another node upon receiving a compressed packet therefrom.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1A is a flow chart depicting an embodiment of a method for communicating data in accord with the present invention;

FIG. 1B presents an embodiment of a system for the transmission of data in accord with an embodiment of the present invention; and

FIG. 2 presents an exemplary structure for the compressed packet (CP) and the acknowledgement packet (ACK).

### DETAILED DESCRIPTION OF THE INVENTION

The ensuing discussion focuses on the representative application of compression and decompression, but once again, it should be understood that the invention can be applied to other forms of complementary packet processing.

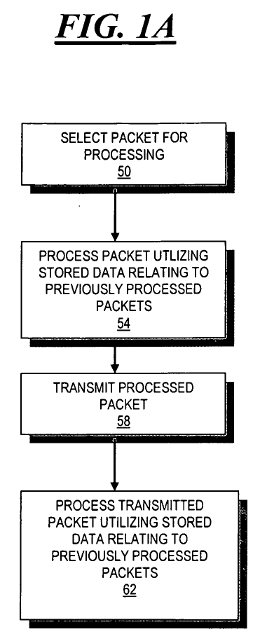

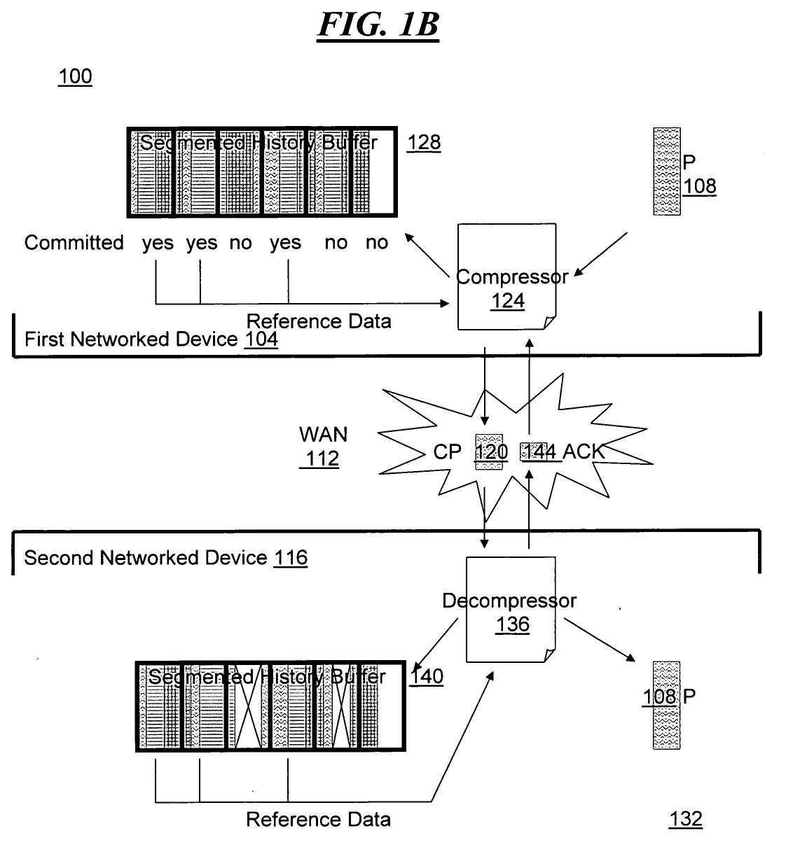

Referring to FIG. 1B, a compressor process 100, operating in a first networked device 104, selects an input packet P 108 and compresses the input packet P 108 for transmission over a WAN 112 to a second networked device 116, producing a compressed packet CP 120 which is transmitted in lieu of the original packet P 108. The compressor 124 maintains a history buffer 128 which during operation is updated to include data from packets which are processed as input by the compressor 124. As input packets are processed, their associated data is added sequentially to the history buffer 128.

In this embodiment, the history buffer 128 is of finite length, and once it is full, the oldest packet data is removed as new packet data is added. Furthermore, the history buffer 128 is structured to contain N discrete data windows, each of which is of L bytes in length. The compressor 124 also maintains a committed flag C(i) for each window. The flag C(i) indicates whether the packet data residing in history buffer window(i) is available as reference data for a compressing a packet. During such a compression operation, the input packet P 108 is processed using data from available history buffer windows in conjunction with a prescribed compression algorithm to produce a compressed packet CP 120 as output. Contemporaneously, the compressor 124 adds the data from the original packet P 108 to the history buffer 128. The compressed packet CP 120 contains header information indicating where in the history buffer 128 the data from the original packet 108 was added. The compressed packet CP 120 is then transmitted over the WAN 112 to the second networked device 116.

Again referring to FIG. 1B, a decompressor process 132, operating in the second networked device 116, decompresses the received compressed packet CP 120 to produce the original packet P 108 and to make it available for subsequent use. The decompressor 136 also maintains a history buffer 140, which during operation is updated to include data from packets which are produced as output from the decompressor 136.

In this embodiment, the history buffer 140 is also structured to contain N discrete data windows, each of which is of L bytes in length. During such decompression operation, the input compressed packet CP 120 is processed using data from history buffer windows in conjunction with a prescribed decompression algorithm to produce the original packet P 108 as output. Contemporaneously, the decompressor 136 adds the data from the output original packet P 108 to the history buffer 140, at the location indicated in the header of the compressed packet CP 120. When the decompressor 136 determines that all original packet data has been added to a particular window (i) of its history buffer 140, it generates an acknowledgement packet ACK 144 indicating that window's data is now available for subsequent decompression operations. The ACK packet 144 is then transmitted over the WAN 112 back to the first networked device 104.

Still referring to FIG. 1B, the compressor process 100, operating in the first networked device 104, receives the ACK packet 144 and sets the committed flag C(i), thereby making that corresponding history buffer window available for subsequent compression operations.

Further Considerations

To provide reliable operation, complementary packet operators (e.g., such as the compressor and decompressor discussed above) should work in concert to handle various manifestations of poor network performance. These include: lost packets, re-ordered packets, corrupted packets, and long transmission latency between the packet operators. To address these issues, embodiments of the present invention include the following features:
Allowance for Lost Packets: When a packet is lost in transit, the only effect is that the history buffer window (or windows) pertaining to that packet is not acknowledged, and thus is unavailable for subsequent packet processing operations. Aside from a minor and transient decrease in performance (e.g., in terms of compression ratio), this has no persistent negative effect on operation. Similarly when an ACK packet is lost in transit, again, the effect is only that the history buffer window pertaining to that acknowledgement is unavailable for subsequent packet processing operations. Furthermore, this occurrence can be minimized by sending multiple ACK packets.
Allowance for Out-of-Order Packets: Divergence routes within the WAN may cause packets to arrive out of sequence with respect to their transmission. The inclusion of explicit history offset values within the headers of these packets allows for their proper processing, regardless of their arrival order, as long as specified out-of-order thresholds are not exceeded.
Discard of Stale Packets: In anomalous cases, certain packets may be especially delayed with respect to other packets. Identifying and discarding these ‘stale’ packets prevents inappropriate processing.
Preventing Draining of Processing History: In an extreme case, ACK packets may not be received by the processor at all. This can occur during a network outage where packets cannot be transmitted over the WAN. In this case, the maintenance of an internal update/no_update state within the packet processor, and its associated indication in the packet headers, can be used to stop and restart the addition of new packet data into the associated history buffers. This prevents the ‘draining’ of the processor's history buffer in the event of a network outage.
Failsafe Reset to Initial State: If, in the event that a packet processor detects that a processed packet cannot be properly processed (e.g., due to extreme network anomalies or a corrupted packet), it can send to its complementary packet operator a RESET ACK, indicating that the complementary operator must reset itself to an initial state. By doing so, the operator pair can then re-establish proper operation.

### Exemplary Operation

Protocol Structures

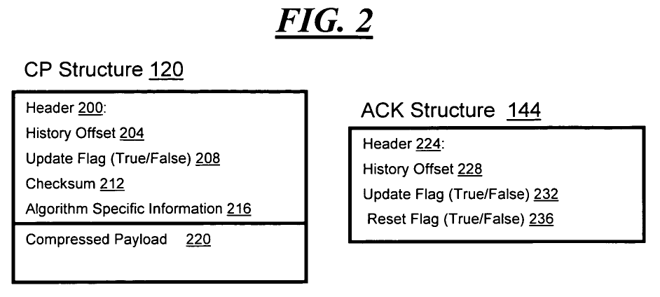

As discussed above, the compressor 124 processes an input packet P 108 and generates a corresponding output compressed packet CP 120 for transmission over the WAN 112 to the decompressor 136. The compressed packet CP 120 contains header information to control the update and use of data in its history buffer 128 for compressing subsequent packets. In addition, the decompressor 136 generates acknowledgement packets, ACKs 144, for transmission back to the compressor 124 for this same purpose. An exemplary structure for the CP 120 and ACK 144 packets is shown in FIG. 2.

Referring to FIG. 2, the CP header 200 contains a starting Offset 204 indicating where in the compressor's history buffer 128 the data from input packet P 108 is placed. This offset likewise indicates where the decompressor 132 should place the data from packet P 108 in its history buffer 140 following decompression. The header 200 also contains an Update Flag 208 indicating whether the compressor 100 is currently in update mode, meaning that new packet data is currently being added to the history buffer 128, as well as a Checksum 212 of the original data from packet P 108. Optionally, the CP header 200 may also contain other information used by the specific compression algorithm 216 which to be made available to the decompressor 136 in servicing that algorithm. Following the CP header 200, the CP contains the Compressed Payload 220 to be processed by the decompressor 136 to produce the original packet P 108.

Again referring to FIG. 2, the ACK header 224 contains a starting Offset 228 indicating the location of a window in the decompressor's history buffer 140 which is being acknowledged as having been successfully filled with data from decompressed packets. It also contains an Update Flag 232 indicating the acknowledged mode of operation, and a Reset Flag 236 indicating whether the compressor process 100 needs to be reset to its initial state in order to re-establish proper operation.

Basic Procedures

To operate in accord with the present invention, an embodiment providing compression typically implements the following five basic procedures:

By the Compressor:
1) Compress_Initialize: This is performed at system startup, or following a failure of the decompressor to successfully process a compressed packet CP.
2) Compress_Packet: This is performed when a packet is available to the compressor for compression, producing a compressed packet CP for transmission over the WAN to the decompressor.
3) Process_Ack: This is performed when the compressor receives over the WAN an ACK packet from the decompressor.

By the Decompressor:
1) Decompress_Initialize: This is performed at system startup, or following a failure of the decompressor to successfully process a received compressed packet CP.
2) Decompress_Packet: This is performed when the decompressor receives a compressed packet CP over the WAN from the compressor which is to be processed, producing an original data packet, P.

For further illustration, a pseudo-code representation of each of these steps is given below.

Compress_Initialize( ):

−>Set history_offset to 0;
−>Set committed_flag(i) for all windows(i) to FALSE;
−>Set update_mode to FALSE;

Compress_Packet (packet P):

−>Set commited_flag(i) to FALSE for:

Any windows(i) affected by adding this data from P to the history buffer;
The windows(i) in the history buffer containing the oldest

MAX_REORDER_BYTES of data;

```
−>Compress P, utilizing history data from any window(i) where
    committed_flag(i) is TRUE, producing CP, while simultaneously adding data
    from P to the history buffer at offset history_offset
−>Construct CP header and transmit CP as follows:
```

−>Set CP header's History Offset to history_offset
−>Set CP header's Update Flag to update_mode
−>Set CP header's Checksum to checksum(P)
−>Set any of CP header's Algorithm Specific Information
−>Transmit CP

−>If update_mode is TRUE

−>Update history_offset to account for data added from packet P
−>If the number of unacknowledged windows currently outstanding has
reached a maximum unacknowledged windows threshold

−>Set update_mode to FALSE

Process_Ack (acknowledgement packet ACK):

−>If ACK Header's Reset Flag is TRUE

−>Compress_Initialize( )

−>Else

−>If update_mode is FALSE

−>If ACK Header's Update Flag is FALSE and ACK Header's
Offset equals history_offset
−> Set update_mode to TRUE

−>Else

−>If ACK Header's Update Flag is TRUE and ACK Header's
Offset is within last the maximum unacknowledged windows

−>Set committed_flag(i) to TRUE for window(i)
corresponding to ACK Header's Offset

Decompress_Initialize( ):

−>Initialize variables controlling the determination of when window are filled

Decompress_Packet (compressed packet CP):

−>Decompress CP, producing P, while simultaneously adding data
from P to the history buffer at offset given in CP header's History Offset
−>If decompress fails

−>Decompress_Initialize( )
−>Construct RESET ACK header and transmit ACK as follows:

−>Set ACK header's History Offset to 0
−>Set ACK header's Update Flag to FALSE
−>Set ACK header's Reset Flag to TRUE
−>Transmit ACK

−>Else

−>If CP header's Update Flag is FALSE

−>Construct NOUPDATE ACK header and transmit ACK as
follows:

−>Set ACK header's History Offset to offset given in CP
header's History Offset
−>Set ACK header's Update Flag to FALSE
−>Set ACK header's Reset Flag to FALSE
−>Transmit ACK

−>Else

−>If window(i) is filled as a result of adding data from P

−>Construct UPDATE ACK header and transmit ACK as
follows:

−>Set ACK header's History Offset to offset
corresponding to window(i)
−>Set ACK header's Update Flag to TRUE
−>Set ACK header's Reset Flag to FALSE
−>Transmit ACK

What is claimed is:

1. A method of communicating data, the method comprising:
a. selecting, at a first node, a packet for processing;
b. processing the packet at the first node utilizing at least in part, stored data relating to previously-processed packets;
c. transmitting the processed packet from the first node to a second node; and
d. processing the transmitted packet at the second node utilizing, at least in part, stored data relating to packets previously processed at the second node.

2. The method of claim 1 further comprising storing, accessibly to the first node, processing data from the processed packet.

3. The method of claim 1 wherein the processing at the first node comprises compression and the processing at the second node comprises decompression.

4. The method of claim 1 wherein the packet is transmitted from the first node to the second node over a wide area network.

5. The method of claim 1 wherein the processing at the first node comprises encryption and the processing at the second node comprises decryption.

6. The method of claim 3 further comprising storing, accessibly to the second node, decompression data from the decompressed packet.

7. The method of claim 3 further comprising transmitting, from the second node to the first node, an acknowledgment indicating successful decompression at the second node of the transmitted packet.

8. The method of claim 7 wherein the acknowledgement is transmitted from the second node to the first node over a wide area network.

9. The method of claim 8 wherein the data used for compressing packets is associated only with compressed packets previously transmitted to the second node and for which acknowledgments were received.

10. The method of claim 1 further comprising transmitting, from the second node to the first node, an acknowledgement indicating successful processing of the transmitted packet at the second node.

11. A device for transmitting data packets over a computer network, the device comprising:
a. a packet buffer;
b. a history buffer for storing processing data from processed packets;
c. a processing module for processing packets from the packet buffer based at least in part on data in the history buffer; and
d. a communication module for transmitting, to destination nodes, packets processed by the processing module.

12. The device of claim 11 wherein the processing module is a compression module, the processing comprising compression.

13. The device of claim 11 wherein the processing module is a decompression module, the processing comprising decompression.

14. The device of claim 11 wherein the communication module transmits over a wide area network.

15. The device of claim 11 wherein the processing module is an encryption module, the processing comprising encryption.

16. The device of claim 11 wherein the processing module is a decryption module, the processing comprising decryption.

17. The device of claim 11 wherein the communication module is further configured to receive an acknowledgment from a destination node indicating successful processing of a packet transmitted by the device.

18. The device of claim 17 wherein the acknowledgement is received from the destination node through a wide area network.

19. The device of claim 17 wherein the data used by the processing module is drawn from packets for which acknowledgments have been received.

20. The device of claim 12 wherein the communication module is further configured to receive compressed packets from other nodes, and the device further comprises:
a. a decompression history buffer; and
b. a decompression module for decompressing packets received from other nodes based at least in part on data in the decompression history buffer and storing decompression data from decompressed packets in the decompression history buffer.

21. The device of claim 20 further comprising functionality for transmitting an acknowledgment to another node upon receiving a compressed packet therefrom.
